(19) United States
(12) Patent Application Publication
(10) Pub. No.: US 2010/0101417 A1
(43) Pub. Date: Apr. 29, 2010

(54) METHOD AND SYSTEM FOR CLEANING ATMOSPHERIC POLLUTION

(76) Inventors: Joseph Chung Kai Wong, Hong Kong (HK); Kwun Fu Lam, Hong Kong (HK)

Correspondence Address: BARRON & YOUNG INTELLECTUAL PROPERTY, P.O. BOX 1484, GENERAL POST OFFICE, HONG KONG, HK

(21) Appl. No.: 12/259,847

(22) Filed: Oct. 28, 2008

(51) Int. Cl. B01D 46/00; B01D 46/46; B01D 46/50

(52) U.S. Cl. 95/273; 55/418; 96/422; 55/383; 96/27

(57) ABSTRACT

A system (10) for cleaning atmospheric pollution, the system (10) including at least ne air inlet (30) of a building (20) to draw polluted air (15) from the atmosphere, an air passageway (55) to direct the polluted air (15) to a filtration system (80) located at the premises of the building (20) to filter the polluted air (15), and at least one air outlet (81) of the building (20) to direct the filtered air (90) into the atmosphere.

### TECHNICAL FIELD

The invention concerns a method and system for cleaning atmospheric pollution.

### BACKGROUND OF THE INVENTION

Atmospheric pollution is a major health and environmental problem in many industrialised cities and towns. Traditionally, focus has been on addressing the emissions at the contaminant source to reduce atmospheric pollution.

Accordingly, there is a desire for a method and system for cleaning atmospheric pollution by permanently removing pollutants from the air. Moreover, there is a further desire that such a method and system is applicable on a large scale to remove vast quantities of pollutants from the air in a low cost manner.

### SUMMARY OF THE INVENTION

In a first preferred aspect, there is provided a method for cleaning atmospheric pollution, the method including drawing polluted air from the atmosphere via at least one air inlet of a building, directing the polluted air to a filtration system located at the premises of the building to filter the polluted air, and directing the filtered air into the atmosphere via at least one air outlet of the building.

The polluted air may be directed via an air passageway.

The air passageway may be any one from the group of a lift shaft, piping or a predetermined arrangement of voids in the building.

The method may further include selecting a face of the building having the at least one air inlet to obtain an optimum air flow rate according to wind direction such that the wind blows the polluted air into the building via the at least one air inlet.

The method may further include selecting a floor of the building having the at least one air inlet such that atmospheric pollution occurring at different altitudes is directed to the filtration system.

The at least one air inlet may be any one from the group of window, door, or opening in a roof of the building.

The method may further include providing at least one fan at a location within the air passageway to draw and direct the polluted air towards the filtration system.

The at least one fan may be provided in a lift within a lift shaft, the lift having a top opening and a bottom opening to permit polluted air to pass through the lift.

In a second aspect, there is provided a system for cleaning atmospheric pollution, the system including at least one air inlet of a building to draw polluted air from the atmosphere, an air passageway to direct the polluted air to a filtration system located at the premises of the building to filter the polluted air, and at least one air outlet of the building to direct the filtered air into the atmosphere.

The air passageway may be any one from the group of a lift shaft, piping or a predetermined arrangement of voids in the building.

The system may further includes an anemometer to measure wind speed and wind direction in order to identify a face of the building to have the at least one air inlet such that an optimum air flow rate is obtained by using the wind.

The at least one air inlet may be any one from the group of window, door, or opening in a roof of the building.

The system may further include at least one fan installed at a location within the air passageway to draw and direct the polluted air to the filtration system.

The at least one fan may be installed in a lift within a lift shaft, the lift having a top opening and a bottom opening to permit polluted air to pass through.

The system may further include an electrostatic precipitator to remove particulate matter from the polluted air, the electrostatic precipitator being located upstream from the filtration system.

The filtration system may be a water filtration system to remove ash and particulate matter from the polluted air.

The system may further include a control system to selectively open and close windows and doors of located on a face of the building determined by the measurement of the anemometer to increase the flow rate of polluted air to be cleaned.

### BRIEF DESCRIPTION OF THE DRAWINGS

Embodiments of the invention are described below with reference to the accompanying drawings, in which:

FIG. 1 is a perspective view from above of a building constructed in accordance with an embodiment of the present invention;

FIG. 2 is a sectional side view of a system for cleaning atmospheric pollution in accordance with an embodiment of the present invention;

FIG. 3 is a sectional side view of a system for cleaning atmospheric pollution in accordance with another embodiment of the present invention;

FIG. 4 is a sectional side view of a system for cleaning atmospheric pollution in accordance with yet another embodiment of the present invention;

FIG. 5 is a sectional side view of a system for cleaning atmospheric pollution in accordance with a further embodiment of the present invention;

FIG. 6 is a process flow diagram of a method in accordance with an embodiment of the present invention; and

FIG. 7 is a sectional side view of a flow forcing coupler used in the system in accordance with an embodiment of the present invention.

### DETAILED DESCRIPTION OF THE DRAWINGS

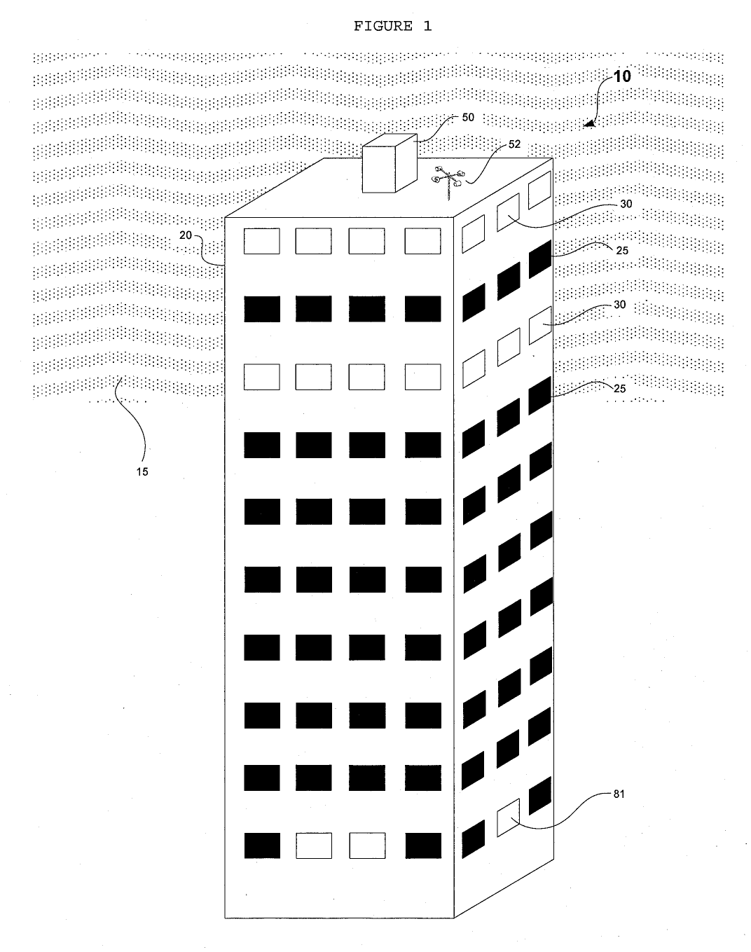

Referring to FIGS. 1 to 5, a system 10 for cleaning atmospheric pollution 15 is provided. The system 10 generally includes at least one air inlet 30 of a building 20, an air passageway 55, a filtration system 80 located at premises of the building 20 and at least one air outlet 81 of the building 20. Preferably, the filtration system 80 is located within the building 20. The air inlet 30 draws polluted air 15 from the atmosphere. The air passageway 55 directs the polluted air 15 to the filtration system 80 where the pollutants are permanently removed from the air. The air outlet 81 directs the filtered air 90 into the atmosphere. The filtered air 90 may be released at ground level or at a higher altitude via air conduits.

The building 20 is intended to function as a pollutant collection system 10. Preferably, the building 20 is a high-rise building with at least nine stories although even a building with a single story may be used. The building 20 has at least one lift shaft 55 and/or vertical ducting/ventilation system. Ideally, the building 20 is located in or around regions or cities that have atmospheric pollution 15 or the presence of smog in the environment. The building 20 may be unoccupied or occupied. Old, unused or buildings unsafe for occupancy are highly suitable for use in the system 20 as they are low cost to use and thus require less start up investment. The system 10 may be installed near power plants, which generate a large amount of polluted air. The system 10 may also be installed in several buildings near a power plant to clean a larger volume of polluted air.

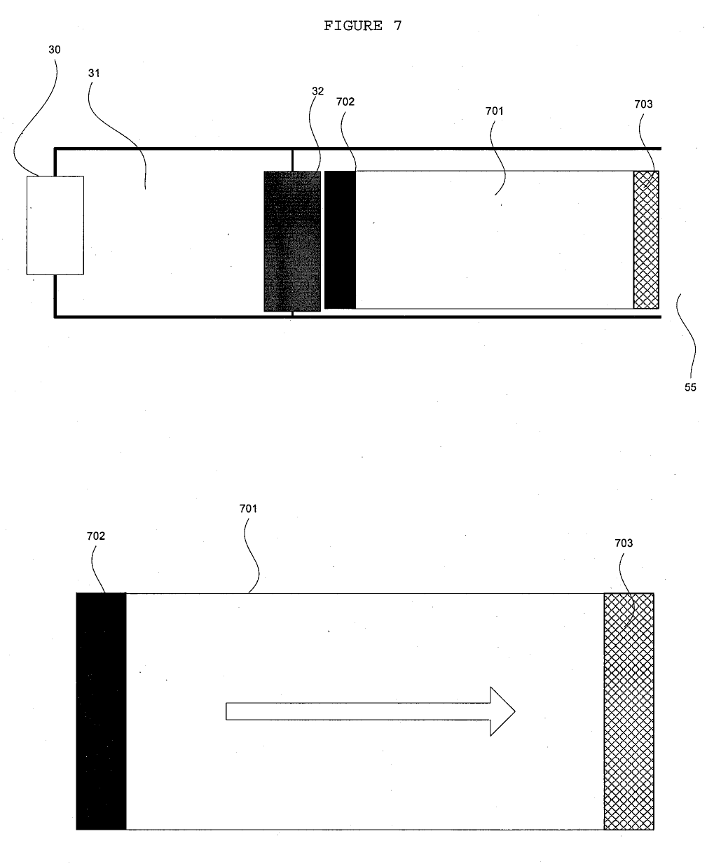

Turning to FIG. 7, the building 20 has windows 30 which function as air inlets 30 in the system 10 to draw in airborne pollution 15 from the atmosphere. In the apartments 31 of the building 20, the windows 30 and doors 32 can be fully or partially opened depending on the wind direction and the source location of pollutants to be cleaned. A flow forcing coupler 701 is positioned between the door 32 of the apartment and the lift door to direct the airborne pollution 15 into the lift shaft 55. The flow forcing coupler 701 may be made from wood or like materials. On one end of the flow forcing coupler 701 a large physical filter 702 is installed to prevent large particles such as debris and physical rubbish or birds from entering the system 10. The filter 702 is positioned at the main door entrance of each apartment or room 31 in the building 20. At the other end of the flow forcing coupler 701 is a driving fan 703. The driving fan 703 assists with drawing and driving the airborne pollution 15 into the lift shaft 55.

The air passageway 55 is defined from the window openings 30 to lift doors on the same floor, and then from the lift doors via the lift shaft 55 down to the water filtration system 80. Although a lift shaft 55 and ducting/ventilation system have been described, any type of air conduit or series of connected air conduits from the openings 30 ultimately to the filtration system 80 may be used. The lift doors for the lift shaft 55 at the airborne collection floor must be kept open to allow the polluted air 15 to flow through towards the ground floor. The entire ground floor is used as a pollutant/dust collection control centre.

An aerodynamic air driving mechanism such as a fan 60 or cyclone, is installed inside the lift shaft 55 to direct the polluted air that is drawn from windows 30 into the lift shaft 55 where polluted air moves downwards towards the lower floors of the building 20. The fans 60 do not always have to be activated if the wind speed is able to generate sufficient air flow.

Pollutants such as ash or particulates in the atmosphere exist or circulate near building 20. The polluted air 15 is drawn into the building 20 via air inlets 30. The polluted air 15 passes through the intermediate flow forcing coupler into the lift shaft 55. Air flow is merged following an air flow path 5 and flows downwards via the lift shaft 55 with assistance from several fans 60 or cyclones blowing downwards. The polluted air 15 arrives at the ground floor of the building 20 to be filtered by the filtration system 80. The polluted air 15 drawn to the ground floor passes through electrostatic precipitators 70 before it is filtered by a water filtration system 80. An example of a water filtration system 80 to be used in the system 10 is disclosed in U.S. provisional patent application 61/021,321 filed on Jan. 15, 2008, the disclosure of which is incorporated herein by reference in its entirety. Dust and ash is passed through this multi-stage water filtration system 80. Over 90% of the fly ash is collected before the air is released into the environment. It is expected that ash and dust with a particle size larger than 100 μm will be captured by the water filtration system 80. An axial fan 70 is provided to direct the air into the water filtration system 80.

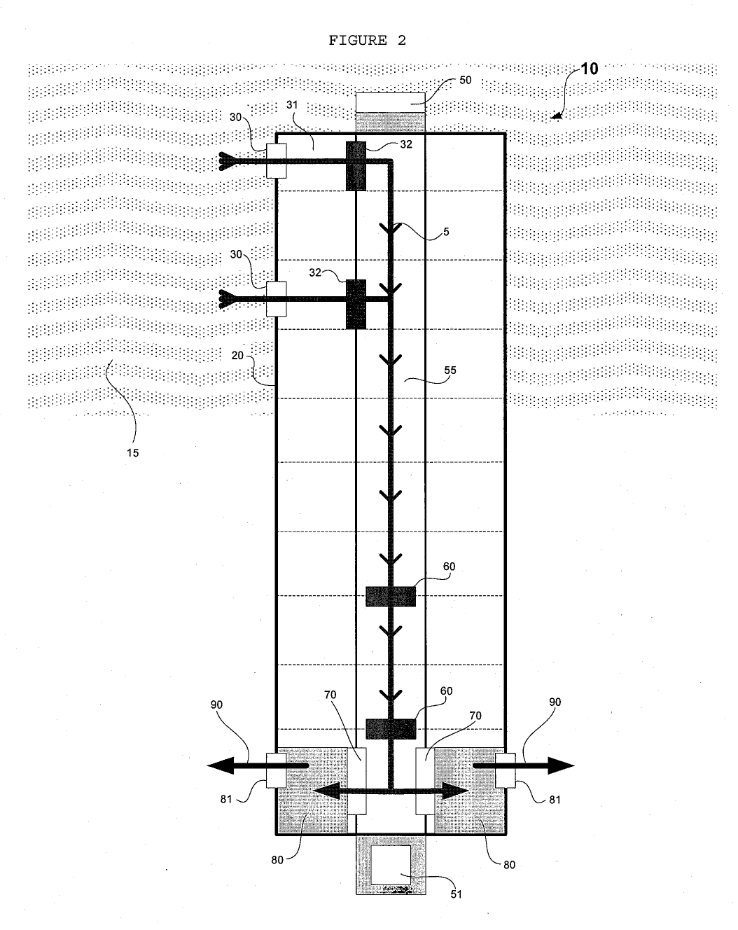

The system 10 may be configured in a different manner subject to the altitude of pollutants existing in the atmosphere. Turning to FIG. 2, the lift car 51 is stationed below the ground floor to provide space for the air flow and the suction fan or cyclone 60. Lift machine room 50 ceases to operate with the lift car cables being removed or left idle.

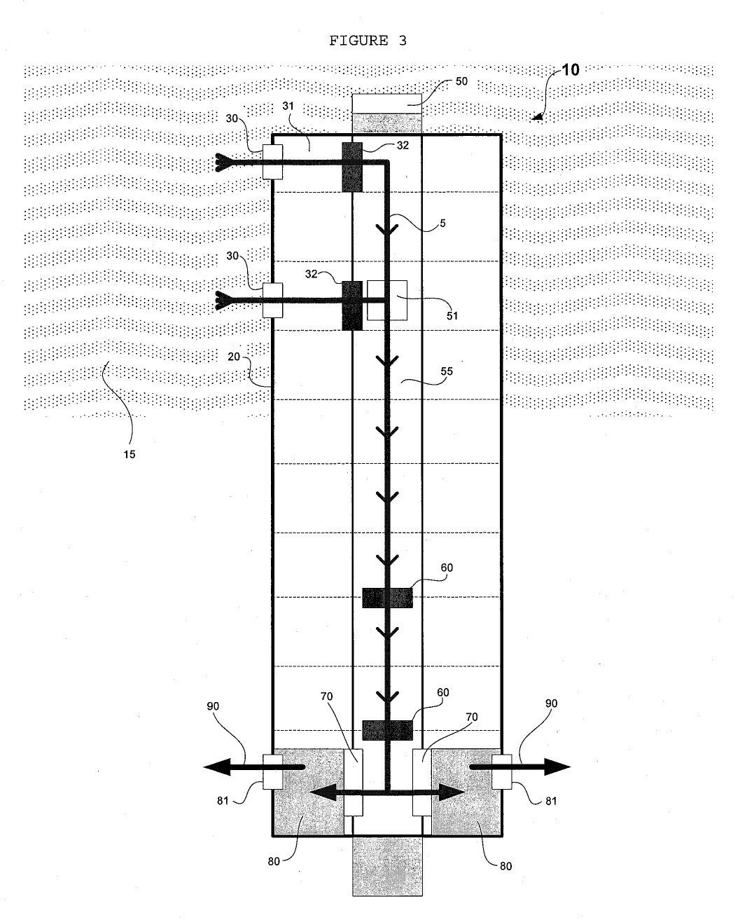

Turning to FIG. 3, if the lift car 51 is used by maintenance personnel to move between floors of the building 20, it is modified by opening the ceiling and floor of the lift car 51 for air to flow vertically through it. When not moving personnel, the lift car 51 is moved to an upper floor to help direct air flow from that floor to the ground floor. A fan or cyclone may be installed at the base of the lift car 51 to blow the polluted air downwards.

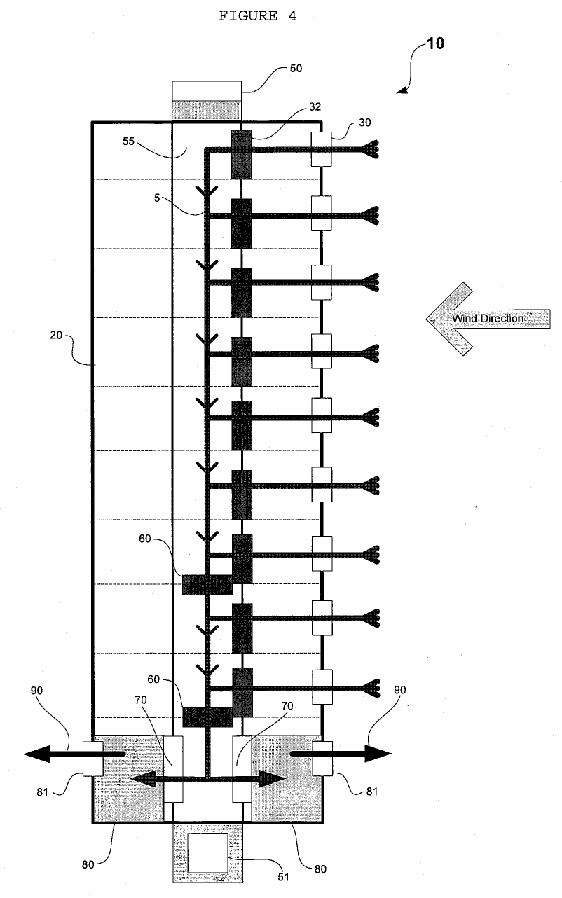

Turning to FIG. 4, if the polluted air 15 is drawn from a single face of the building 20, then windows 30 are opened on that side of the building 20. The other side of the building 20 may be for other activities, such as occupancy or storage space. A typical ten story high rise building 20 has windows with a size of 100 cm×120 cm and a door entrance of 90 cm×200 cm. The windows of nine floors may be used as air inlets 30. In one embodiment, only one window 30 is opened on each floor. Fans with a minimum 400 cubic feet per minute (CFM) are installed at a flow forcing coupler. A minimum of 4000 cubic feet per minute volume of air is drawn into the lift shaft 55. The lift shaft 55 has a cross sectional area of 180 cm×180 cm. The lift car 51 is idle and fully lowered into a pit at the bottom of the lift shaft 55 to allow sufficient space for the air to flow into the water filtration system 80 located on the ground floor.

The polluted air 15 is then drawn into the two separate but similar water filtration systems 80. Polluted air is drawn into the filtration system 80 by an axial fan running at about 3000 CFM. The polluted air flows from the lift shaft 55 into the water filtration system 80 at about 5 meters per second. For good performance, the system 10 requires the air flow rate to be maintained at about 5 meters per second. The air flow inside the lift shaft is about 5 meters per second which is substantially similar to the flow rate of the exhaust air 90. The flow rate of the exhaust air 90 is maintained at about 6 metres per second.

There is about a 50% reduction in the level of particulates in the air 90 exiting the air outlets 81 compared to the polluted air arriving through the air inlets 30. There is about a 90% reduction in ash in the air 90 exiting the air outlets 81 compared to the polluted air arriving through the air inlets 30. After successful treatment, the respiratory suspended particulate (RSP) level in the air is PM₁₀ standard.

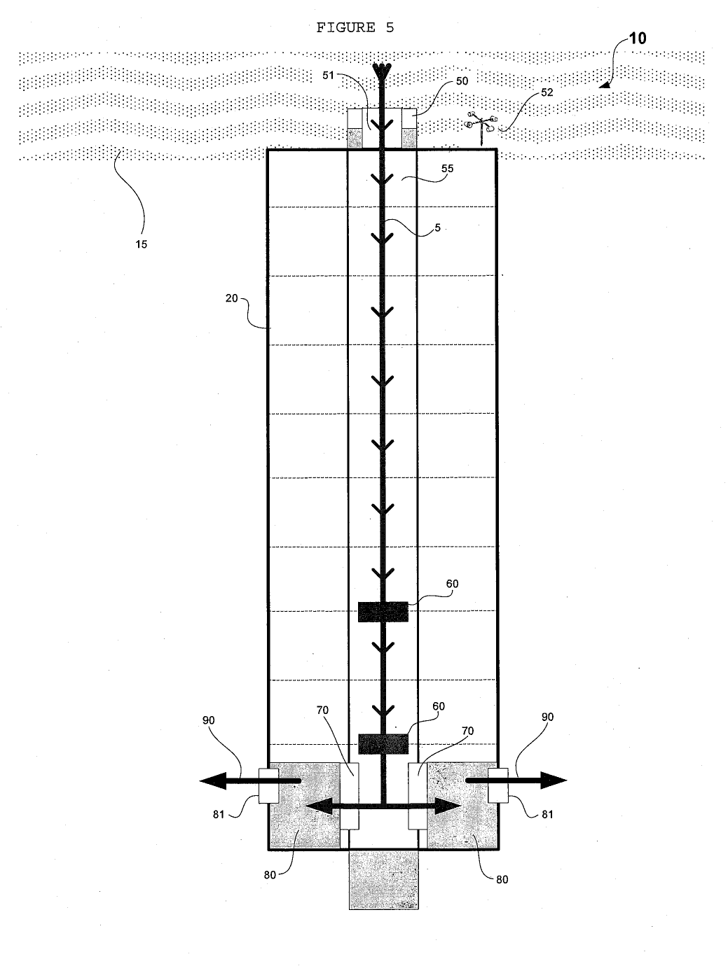

Turning to FIG. 5, if the polluted air 15 is drawn from above the building 20, the lift car 51 is moved to the maximum height near the lift machine room 50 at the top of the building 20. The polluted air 15 is then drawn substantially vertically down the lift shaft 55 until it reaches the ground floor where it is filtered by the water filtration system 80.

In order to obtain an optimum flow rate along the air flow path 5, an anemometer 52 is installed on the exterior of the building 20, for example, the roof. The anemometer 52 measures wind direction and wind speed. The measurement from the anemometer 52 is processed by a processor to determine which face of the building 20 the windows 30 should be opened to obtain an optimum flow rate of polluted air 15 to enter the building 20 and be cleaned. This also means the fans 60 may be turned off and reduce electricity consumption if the wind speed is sufficient to push the polluted air 15 down to the ground floor.

In another embodiment, instead of using an anemometer 52, historic annual wind direction data may be used to determine which face of the building 20 the windows should open during particular months of the year.

Atmospheric pollution at lower altitudes may be cleaned by the system 10. A typical ten story high rise building 20 has windows having a size of 100 cm×120 cm and door entrances having a size of 90 cm×200 cm. Nine floors of the building 20 may be used as air inlets 30. Ten windows 30 are opened on the second floor and two fans with minimum 400 CFM are installed at the flow forcing coupler on each side of the lift entrance. Two lift doors are left open with the flow forcing couplers installed either in an opposite manner to each other or orthogonally depending on the actual condition. The lift car 51 is stopped and left idle at the third floor to leave sufficient air space for the air to flow through the water filtration system 80. A total of 800 CFM of polluted air 15 is directed into the lift shaft 55 with cross-sectional area of 180 cm×180 cm.

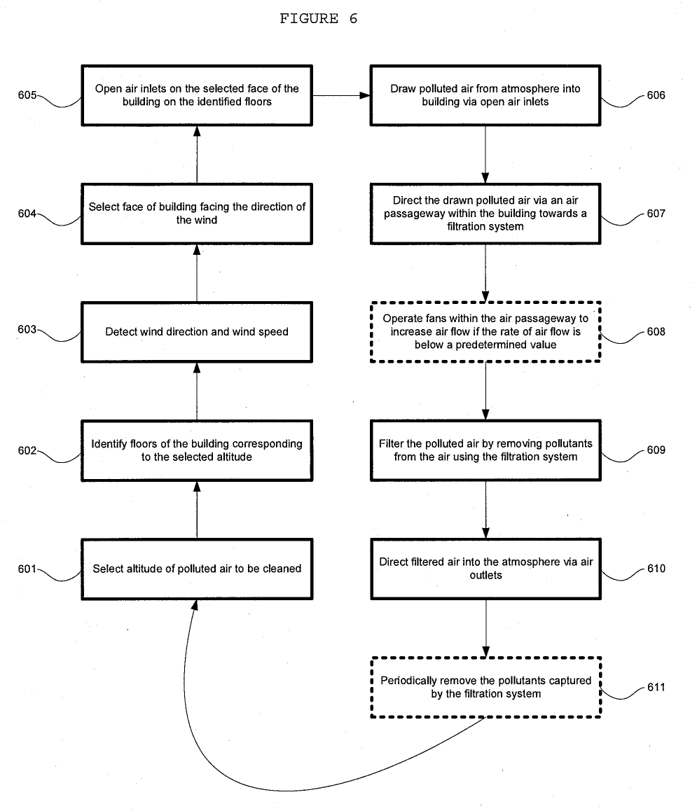

Referring to FIG. 6, a typical scenario of the system 10 during operation is described. Firstly, the altitude of where the polluted air 15 to be cleaned is determined (601). The floors corresponding to the determined altitude are identified (602). Alternatively, altitude need not be determined and simply all floors of the building 20 above the ground are used. The wind speed and wind direction are detected (603) by the anemometer 52. The face of the building in the direction of the wind direction is selected (604). Alternatively, the face of the building 20 need not be identified and one or more faces of the building 20 are used. The windows 30 are opened (605) as well as the doors 32 of the apartments/rooms of the building 20 to provide an access route for the polluted air 15 to reach the lift shaft 55. The polluted air 15 flows (606) into the building 20 following an air flow path 5 down the lift shaft 55 towards the ground floor. The polluted air is directed (607) to follow this air flow path 5 via an air passageway 55 defined from the window 30 through the door of the apartment and into the lift shaft 55 and to the water filtration system 80. Fans 30 in the lift shaft 55 may be operated (608) to increase the air flow rate if the natural wind speed is not fast enough. When the polluted air arrives at the ground floor, it is filtered (609) by an electrostatic precipitator 70 and water filtration system 80. The filtered air 90 is directed (610) back into the atmosphere via air outlets which may also be windows 81. From time to time, maintenance personnel remove (611) the collected pollutants at the filters and dispose of them in known ways.

The costs of implementing the system 10 are minimal. Such costs would include leasing costs of the building 20 (if necessary), and costs for a person to routinely remove the pollutants captured by the water filtration system 80, clean the electrostatic precipitator 70 and filter 32 and open the appropriate windows 30 and doors to receive the atmospheric pollution 15. Alternatively, the operation of windows 30 and doors may be controlled automatically using a control system of pneumatic pistons to open and close the appropriate windows 30 and doors. This control system may be controlled by a central computer which receives wind measurements from the anemometer 52. Electrical usage costs may be minimized by powering the fans 60 and other electrical devices by solar panels installed on the roof of the building 20 or other renewal energy sources.

The total cross sectional area of the air inlets 30 may be larger than the total cross sectional area of the air outlets 81. This creates additional air pressure by forcing a larger volume of air through the building 20 to be cleaned and out via the air outlets 81. The additional air pressure assists in pushing the polluted air through the building 20 with less reliance on the fans 60 to blow.

Atmospheric pollution may include CO₂ and SO₂ when they exist in excessive amounts in the atmosphere.

Although it has been described that the water filtration system 80 is located on the ground floor, it is envisaged that it may be located on any floor in the building 20.

Although a water filtration system 80 has been described, it is envisaged other types of filtration systems are possible which are capable of permanently removing pollutants from the air.

Although windows 30 have been described as the air inlet 30 and air outlet 81, openings in the building 20 with any shape or form which permit polluted air to flow into the building 20 is envisaged as a suitable air inlet 30 and openings in the building 20 with any shape or form which permit filtered air 90 to leave the building 20 to the atmosphere is envisaged as a suitable air outlet 81.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A method for cleaning atmospheric pollution, the method comprising:
drawing polluted air from the atmosphere via at least one air inlet of a building;
directing the polluted air to a filtration system located at the premises of the building to filter the polluted air; and
directing the filtered air into the atmosphere via at least one air outlet of the building.

2. The method according to claim 1, wherein the polluted air is directed via an air passageway.

3. The method according to claim 2, wherein the air passageway is any one from the group consisting of a lift shaft, piping or a predetermined arrangement of voids in the building.

4. The method according to claim 1, further comprising selecting a face of the building having the at least one air inlet to obtain an optimum air flow rate according to wind direction such that the wind blows the polluted air into the building via the at least one air inlet.

5. The method according to claim 1, further comprising selecting a floor of the building having the at least one air inlet such that atmospheric pollution occurring at different altitudes is directed to the filtration system.

6. The method according to claim 1, wherein the at least one air inlet is any one from the group consisting of: window, door, or opening in a roof of the building.

7. The method according to claim 1, further comprising providing at least one fan at a location within the air passageway to draw and direct the polluted air towards the filtration system.

8. The method according to claim 7, wherein the at least one fan is provided in a lift within a lift shaft, the lift having a top opening and a bottom opening to permit polluted air to pass through the lift.

9. A system for cleaning atmospheric pollution, the system comprising:
at least one air inlet of a building to draw polluted air from the atmosphere;
an air passageway to direct the polluted air to a filtration system located at the premises of the building to filter the polluted air; and
at least one air outlet of the building to direct the filtered air into the atmosphere.

10. The system according to claim 9, wherein the air passageway is any one from the group consisting of: a lift shaft, piping or a predetermined arrangement of voids in the building.

11. The system according to claim 9, further comprising an anemometer to measure wind speed and wind direction in order to identify a face of the building to have the at least one air inlet such that an optimum air flow rate is obtained by using the wind.

12. The system according to claim 9, wherein the at least one air inlet is any one from the group consisting of: window, door, or opening in a roof of the building.

13. The system according to claim 9, further comprising at least one fan installed at a location within the air passageway to draw and direct the polluted air to the filtration system.

14. The system according to claim 13, wherein the at least one fan is installed in a lift within a lift shaft, the lift having a top opening and a bottom opening to permit polluted air to pass through.

15. The system according to claim 9, further comprising an electrostatic precipitator to remove particulate matter from the polluted air, the electrostatic precipitator being located upstream from the filtration system.

16. The system according to claim 9, wherein the filtration system is a water filtration system to remove ash and particulate matter from the polluted air.

17. The system according to claim 11, further comprising a control system to selectively open and close windows and doors of located on a face of the building determined by the measurement of the anemometer to increase the flow rate of polluted air to be cleaned.
